(19) United States
(12) Patent Application Publication
(10) Pub. No.: US 2012/0143690 A1
(43) Pub. Date: Jun. 7, 2012

(54) SYSTEM AND METHOD FOR DELIVERING A GEOGRAPHICALLY RESTRICTED IN-STORE PROMOTION TO A CONSUMER

(75) Inventors: Gregory Hansen, Twp. of Washington, NJ (US); Seth H. Sarelson, New York, NY (US); Johnathan A. Treiber, New York, NY (US)

(73) Assignee: ONCARD MARKETING, INC., New York, NY (US)

(21) Appl. No.: 13/028,514

(22) Filed: Feb. 16, 2011

Related U.S. Application Data
(63) Continuation-in-part of application No. 13/008,389, filed on Jan. 18, 2011.
Application No. 13/008,389 is a continuation-in-part of application No. 13/007,824, filed on Jan. 17, 2011.
Application No. 13/007,824 is a continuation-in-part of application No. 12/958,984, filed on Dec. 2, 2010.

(51) Int. Cl. G06Q 30/00

(52) U.S. Cl. 705/14.58

(57) ABSTRACT

A system and method for delivering a geographically restricted in-store promotion to a consumer includes storing in an offer database a plurality of offer data items for use in creating an in-store promotion and at least one participating store location. In response to receiving a request from a consumer device to present the in-store promotion, the server determines if the consumer device is within a predetermined geographic location of the participating store location without requesting additional information from a consumer operating the consumer device. If the consumer device is within the predetermined geographic location of the participating store location, the server dynamically generates the in-store promotion using at least one of the plurality of data items stored in the offer database. Once generated, the server transmits the in-store promotion to the consumer device.

### CROSS-REFERENCE TO RELATED APPLICATIONS

This application is a continuation-in-part of co-pending U.S. patent application Ser. No. 13/008,389 entitled, “A System and Method for Delivering a Restricted Use In-Store Promotion to a Consumer” filed Jan. 18, 2011, which is a continuation-in-part of co-pending U.S. application Ser. No. 13/007,824 entitled, “A System and Method for Delivering an Authorized In-Store Promotion to a Consumer” filed Jan. 17, 2011, which is a continuation-in-part of co-pending U.S. application Ser. No. 12/958,984, entitled, “A System and Method for Delivering an In-Store Promotion to a Consumer” filed Dec. 2, 2010, the entire contents of which are hereby incorporated by reference.

### STATEMENT REGARDING FEDERALLY SPONSORED RESEARCH OR DEVELOPMENT

Not applicable.

### REFERENCE TO A SEQUENCE LISTING, A TABLE, OR COMPUTER PROGRAM LISTING COMPACT DISC APPENDIX

Not applicable.

### BACKGROUND OF THE INVENTION

The invention relates generally to the field of sales and marketing. More particularly, the invention relates to the creation, distribution, and tracking of in-store promotions via digital distribution channels and ensuring that only authorized consumers receive the promotions.

In-store promotions are promotions that can be used at the portion of a merchant's business that takes place at a physical or “brick-and-mortar” location. Previous implementations of distributing coupons and other types of in-store promotions through digital media have had serious limitations on both the distribution and tracking of these in-store promotions as well as impeding consumer utilization. Distributing offers via digital media, if not done properly, is difficult to control and can lead to fraudulent distribution and redemptions.

Traditionally, most in-store promotions have been distributed as static images or links to static images that cannot be tracked to a distribution channel (ex. website, email, etc.) or capture more granular detail about that distribution channel (ex. paid search keywords) or consumer (ex. email address). Furthermore, these static images or links to static images can create security issues when an in-store promotion or offer is posted on an unauthorized website, sent via email, shared via social media, or shared via other distribution methods to unintended recipients due to lack of security. These issues have traditionally made advertisers reluctant to utilize digital in-store promotions because these in-store promotions are difficult to control. This reluctance to utilize digital in-store promotions has adversely affected consumers as well by decreasing the number of digital in-store promotions that advertisers make available.

Companies have attempted to address some security issues by requiring consumers to register for a service and install software on their personal computer necessary to view and print the in-store promotions (see Barnett, et al. U.S. Pat. Nos. 6,321,208 and 6,336,099). Many advertisers and consumers view a requirement to register and install software to obtain an in-store promotion as overly invasive and burdensome. These requirements have hindered adoption of digital in-store promotions by both advertisers and consumers.

Requiring user registration and client software installation enables advertisers to provide tracking and security unique to a user's computer, but creates other problems. Consumer adoption and privacy concerns are prevalent with registration and client software. The client software needs to communicate with a server via some internet connectivity and is often flagged as spyware or malware and is blocked by many firewalls and corporate proxy servers. Consumer adoption has suffered greatly with registration due to privacy concerns and lack of support across different computer operating systems. Client software does not work across all computer systems and large populations of consumers are unable to use the software due to incompatibility issues. As consumers upgrade their systems they will need to reinstall and potentially re-register the software.

Consumer registration is also limited to tracking the consumer information used when registered and, in some cases, the distribution channel in broad terms. Distribution via internet search engines, mobile phones and other media where information is dynamic is not possible. Consumer information is often not reliable due to consumers entering in fraudulent information to protect their actual information. Many free email services exist which are used as the registered email address so consumers do not provide their true email address thus defeating the tracking goal.

Technical issues with client software aside from operating system compatibility exist. Client software is often not compatible with many printers. Both old and new printers are not supported or will be lagging in support. End user support often suffers because the software vendor needs to be contacted if print issues arise. Consumers are often confused and frustrated because the website they find the in-store promotion cannot support the client software.

One of the most popular methods for distributing coupons is via email. Advertisers will often segment an email database and send special in-store promotions to different segments of the database to drive an in-store purchase with a promotion. Unfortunately, emails are often forwarded to unintended or unauthorized recipients, which can be very problematic for advertisers that have a limited budget for a promotion and only want the desired recipients to be able to access the promotion. In addition, advertisers are not always able to control the number of times that the promotion is viewed and/or printed.

An additional problem related to digital distribution of in-store promotions for advertisers is that advertisers often like to create promotions that are only accepted at certain participating stores. This has been fairly straightforward with traditional media such as newspapers or billboards. Digital media introduces complexity, however, in that a promotion intended for a certain group of stores will likely end up circulated across the internet and other digital media to consumers located outside of the region where the targeted stores are located. This often results in consumers trying to redeem the promotion at non-participating stores, which frequently causes a dispute with a cashier or sales associate over acceptance of the promotion.

### BRIEF SUMMARY OF THE INVENTION

The invention relates generally to a method and system for delivering an in-store promotion to a consumer. The method includes storing in a database a plurality of predetermined data fields and a plurality of tracking methods for use in creating an in-store promotion. In one embodiment, the database is a secure database for storage of in-store promotion images, in-store promotional text, barcode(s) symbology, structure, and configuration settings for each in-store promotion. The advertiser issuing the in-store promotion provides the information for the predetermined data fields so that the offer may be identified. In one embodiment, the predetermined data fields include the advertiser's/retailer's name and the type of offer. The predetermined data fields may also include the validity dates of the offer and participating store locations. In another embodiment, each component of an in-store promotion is stored separately and independently within the system so that the components may be reused, and distributed separately or in whole. The advertiser may also select one of the tracking methods.

In response to receiving a request from a consumer browser executing on a consumer device to present the in-store promotion, a server in communication with the database dynamically generates the in-store promotion using the information received from the advertiser. In generating the in-store promotion, the server does not request any additional information from the consumer operating the consumer device. Once generated, the server transmits the in-store promotion to the consumer browser. The server also does not send any client software to be stored by the consumer device.

The system provides a usable in-store promotion to an end user/consumer without the need for any registration within the system and without any client software specific to the system. In one embodiment, the in-store promotion can be represented to the consumer in the form of a printable in-store promotion, in-store promotion code, SMS/MMS/email to a mobile phone with barcode, SMS/MMS/email to mobile phone with in-store promotional code, RFID update, etc. In the various embodiments, the offer identifier may be contained in the barcode, in-store promotional code, or other applicable information per the respective delivery mechanism, but can identify information such as, but not limited to, the distribution channel, search keywords, consumer/member identifier (not registered within the system), or any other discretionary information the retailer or advertiser desires to track.

In yet other embodiments, in-store promotions can be configured with fraud protection features that are based on rules the retailer or advertiser sets. In one such embodiment, fraud protection can be turned off or used to control how many times an in-store promotion is printed, printed by a particular consumer, what websites the in-store promotion can be posted on, and/or if the in-store promotion can be forwarded to unintended consumers. In certain embodiments, each fraud protection feature can be adjusted in real time and reset in real time. In other embodiments having fraud protection, in-store promotions are delivered via links each having a unique parameter. The links are particularly effective for email, but can be used via any digital distribution channel. Each link has a unique parameter as in the following example:

http://images.revtrax.com/RevTrax/amf.jsp?viewType=viewFull&programId=10305771&merchantId=10231201&affiliateId=10306429&uid=UniqueParameter
Only links that contain the registered unique parameters are authorized and therefore allowed access to the promotion. When a consumer clicks on a valid link, the user can view, print or perform other operations on the promotion. When a consumer clicks on an invalid or deactivated link, the consumer will be shown an error message or redirected to another page, such as the advertiser's loyalty/email club page.

In another embodiment, the unique parameter may be used to control how many times an in-store promotion is viewed or printed. For example, the advertiser may desire the link to be a single-use link, that is, a link that may only be used to access the in-store promotion a single time. In one such embodiment, the unique parameter is assigned a corresponding status, such as active/inactive. Only links that contain the registered unique parameters having an “active” status are allowed to access the promotion. When a consumer invokes the single use link for the first time, the consumer can view or print the in-store promotion. The status of the parameter is then changed to “inactive”. As described above, when a user invokes an invalid or deactivated link, the consumer may be shown an error message or redirected to another page, such as the advertiser's loyalty/email page. In another embodiment, the advertiser can set the number of times that an in-store promotion may be viewed and/or printed to any number that the advertiser desires.

In still another embodiment, an in-store promotion can be configured with a “digital fence”, which is a security feature that enables an advertiser to specify that only consumers from certain predetermined geographic locations can access a promotion. For example, when a consumer invokes a link to an in-store promotion, the system will look up the physical location of the consumer's computer, mobile phone or other electronic device. Only a consumer located within a predetermined geographic location (i.e. within a 5 mile radius of a participating store) will be able to access the promotion. When a consumer from outside the desired geographic location invokes a link to the promotion, the consumer will be shown an error message, a promotion relevant for the consumer's geography, or redirected to another page, such as the advertiser's loyalty/email club page.

It is therefore an object of the present invention to provide a system and method whereby in-store promotions can be distributed and tracked, along with all advertiser-requested information, without the need for consumer registration and without the need for client software installation. Another object of the invention is to provide a system which provides a mechanism to create, store and distribute in-store promotions across multi-media channels including, but not limited to, print, email, internet, mobile phone, and television. Yet another object of the invention is to prevent fraudulent use of coupons and provide a system and method whereby in-store promotions are delivered only to authorized consumers. Still another object of the invention is to enable an advertiser to set the number of times that an in-store promotion may be viewed and/or printed. A further object of the invention is to enable an advertiser to create a “digital fence”, that is to specify that only consumers within certain predetermined geographic locations can access a promotion.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1A is a flowchart representation of an embodiment of a process for delivering an in-store promotion to a consumer according to the present invention;

FIG. 1B is a flowchart representation of an embodiment of a process for creating an in-store promotion according to the present invention;

FIG. 2 is a block diagram an embodiment of a system according to the present invention illustrating typical consumer interactions with an in-store promotion created using the system;

FIG. 3 is a flowchart representation an embodiment of a process for generating a barcode according to the present invention;

FIG. 4A is a block diagram of an embodiment of a system for delivering authorized in-store promotions to consumers;

FIG. 4B is a flowchart representation of an embodiment of a process for determining if a consumer is authorized to receive an in-store promotion according to the present invention;

FIG. 5 is a flowchart representation of an embodiment of a process for delivering a restricted use in-store promotion according to the present invention;

FIG. 6A is a block diagram of an embodiment of a system for delivering geographically restricted in-store promotions to consumers; and

FIG. 6B is a flowchart representation of an embodiment of a process for determining if a consumer may receive a geographically restricted in-store promotion according to the present invention.

The attached drawings are intended to better illustrate the present invention without limiting it in any manner whatsoever. Like reference characters in the respective drawn figures indicate corresponding parts or steps.

### DETAILED DESCRIPTION OF THE INVENTION

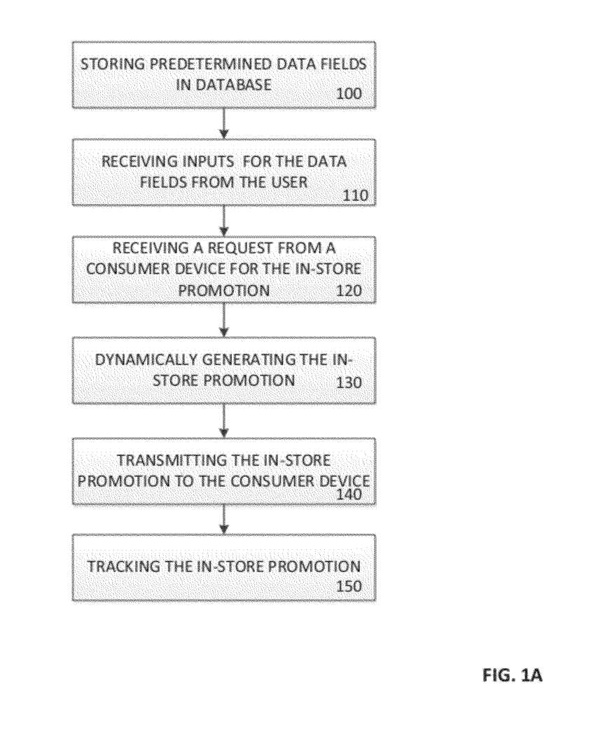

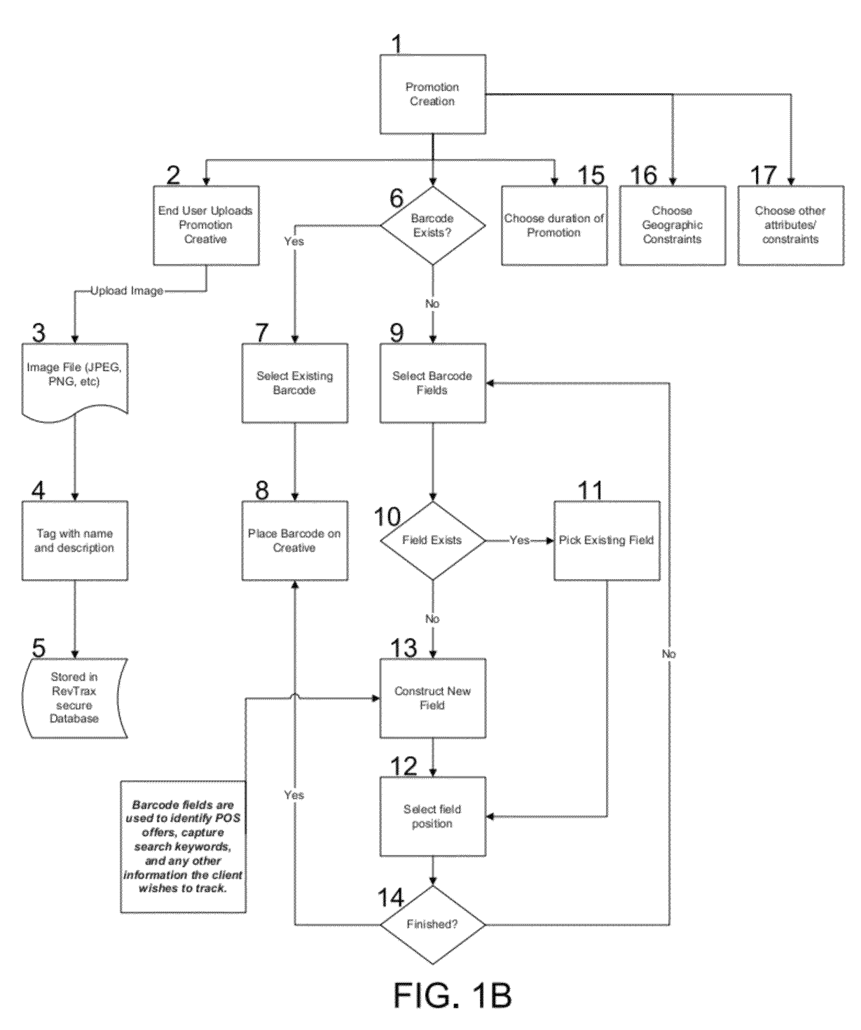

Referring to FIG. 1A and in brief overview, an embodiment of a method for delivering an in-store promotion to a consumer includes storing in a database a plurality of predetermined data fields for use in creating an in-store promotion in step 100. A consumer may be an individual or any other entity to which the advertiser desires to present with the offer. The predetermined data fields are to be completed by the advertiser or the advertiser's agent to define the in-store promotion. In various embodiments, the advertiser may be a retailer, a service provider such as a restaurant, a manufacturer, an advertising agency, or any other entity or person who desires to provide a promotion to a consumer. The retailer, advertiser or other entity offering a promotion may also be referred to herein as the “user”. In one embodiment, the database further includes a plurality of tracking methods that may be selected by the advertiser to track the in-store promotion. In one embodiment, the database is a secure database for storage of in-store promotion images, in-store promotional text, barcode(s) symbology, structure, and configuration settings for each in-store promotion. Next, in step 110, the advertiser issuing the in-store promotion provides the information or inputs for the predetermined data fields so that the offer may be identified. In one embodiment, the predetermined data fields include the advertiser's/retailer's name and the type of offer. The predetermined data fields may also include the validity dates of the offer and participating store locations. In yet another embodiment in which the in-store promotion will include a bar code, the plurality of predetermined data fields includes selectable bar code structures. The advertiser must provide inputs for a sufficient number predetermined data fields so that the offer may be identified. In another embodiment, each component of an in-store promotion is stored separately and independently within the system so that the components may be reused, and distributed separately or in whole. The advertiser may also select one of tracking methods. The advertiser may also input an element not previously stored in the database to include in the in-store offer.

Next, in step 120, the system receives a request from a consumer device for the in-store promotion. In response to receiving a request from a consumer device to present the in-store promotion, a server in communication with the database dynamically generates the in-store promotion using the information received from the advertiser in step 130. In generating the in-store promotion, the server does not request any additional information from the consumer operating the consumer device. In one embodiment, the request is sent from a consumer browser operating on a consumer device. In another embodiment, the request is sent by the consumer invoking a hyperlink. In yet another embodiment, the request may be received via an email, SMS or text message, or any other method for communicating a request to the server.

In one embodiment, the server dynamically generating the in-store promotion generates an offer identifier that may be used to identify the in-store promotion. The offer identifier may be a bar code, a bar code capable of being read by a point of sale device at a store, an in-store promotional code or any other picture, text, sound, graphic or other identifying mechanism that may be used to identify the offer. In an embodiment in which the server generates a bar code, the bar code may be an additional bar code to a bar code the advertiser has already placed on the in-store offer. In yet another embodiment, the offer identifier is included a single bar code placed on the in-store offer. In this embodiment, the single bar code conveys all the information required by the advertiser and is in a format already recognized by the advertiser's equipment.

Once generated, in step 140 the server transmits the in-store promotion to the consumer device. In transmitting the promotion to the consumer, the server does not send any system-specific client software to be stored by the consumer device. The system provides a usable in-store promotion to an end user/consumer without the need for any registration within the system and without any client software specific to the system. In one embodiment, the server transmits the in-store offer to the consumer device through an electronic communication channel. In one embodiment, the in-store promotion can be represented to the user in the form of a printable in-store promotion, in-store promotion code, SMS/MMS/text message/email to a mobile phone with barcode, SMS/MMS/text message/email to mobile phone with in-store promotional code, RFID update, etc. In the various embodiments, the offer identifier may be contained in the barcode, in-store promotional code, or other applicable information per the respective delivery mechanism, but can identify information such as, but not limited to, the distribution channel, search keywords, consumer/member identifier (not registered within the system), or any other discretionary information the retailer or advertiser desires to track.

As described above, the advertiser may select a tracking method. In an embodiment of the system in which the advertiser has selected a tracking method, the system proceeds to step 150 and tracks the in store promotion upon the consumer accessing the in-store promotion. In yet another embodiment in which the advertiser selects a tracking method, the system tracks the consumer selecting to print the in-store promotion. In still another embodiment, the system uses the tracking method to track the in-store promotion once the consumer redeems the in-store promotion at a store. The tracking methods may include methods for tracking distribution channels, search keywords entered into a browser and/or consumer identification information, or any other discretionary information the retailer or advertiser desires to track.

In one embodiment, in order to track the promotion, the system includes identifying information in the offer identifier. The identifying information may identify the method through which the offer was distributed to the consumer, the internet search words used by the consumer in locating the offer, consumer identification information, or other information the advertiser desires to track. For example, if the consumer requested the offer by invoking a URL, the offer identifier could identify the URL or a reference to the URL that the consumer invoked. The URL could then be tracked in the promotion. In another embodiment, the offer identifier could identify the IP address of the consumer's device or a reference to the IP address of the consumer's device. The IP address of the consumer's device could then be tracked in the promotion. In still another embodiment, if the consumer requested the offer by invoking a URL that contained or passed the consumer's membership or privilege card identifier (previously associated with the consumer), the offer identifier may include the consumer's membership or privilege card identifier. The consumer information may be tracked back to the consumer by the system, or it may be tracked back to the consumer by a separate system maintained by the advertiser. In yet another embodiment, the system stores the tracking information and information that may be later matched with the tracking system is included in the offer identifier. For example, the system may include the number 123 in the offer identifier, and the system may associate the number 123 with a specific consumer member number. When the offer with the number 123 in the offer identifier is redeemed, the system will determine that the number 123 is associated with the consumer member number and will determine that the specific consumer redeemed the offer. In other embodiments, the consumer information may be tracked back to the consumer by the system, or it may be tracked back to the consumer by a separate system maintained by the advertiser. For example, the system may share with the advertiser that the number 123 was assigned to a specific consumer member number and then the advertiser or advertiser's system the specific consumer that redeemed the offer.

In still another embodiment, the system may generate and send a cookie to the consumer's device. It is important to note that the cookie is not application-specific software that is required to be stored or executed by the consumer device in order for the consumer to receive/print/redeem the offer. In one such embodiment, the offer identifier includes information for the cookie.

In yet other embodiments, in-store promotions can be configured with fraud protection features that are based on rules the retailer or advertiser sets. In one such embodiment, fraud protection can be turned off or used to control how many times an in-store promotion is printed, printed by a particular consumer, what websites the in-store promotion can be posted on, the geographic location(s) of consumers who may access the in-store promotion, and/or if the in-store promotion can be forwarded to unintended consumers. In certain embodiments, each fraud protection feature can be adjusted in real time and reset in real time.

Referring to FIG. 1B, an embodiment of a method for creating an in-store promotion is shown. In one embodiment, the system provides for the creation and management of in-store promotions through a user interface that is accessible to the advertiser (user) via a secure login. In addition, the user may have fine grained control over the distribution channels. In step 1, the retailer, advertiser or other entity offering a promotion creates the promotion. As described above, the retailer, advertiser or other entity offering a promotion may also be referred to herein as the “user”. Next in step 2, the user uploads a promotion creative. The promotion creative may include the “look and feel” of the in-store promotion that the consumer views. Different in-store promotion creative may be applicable or better suited for different types of distribution channels. The promotion creative may be an image file, text file, sound file, video file or any combination of the foregoing. Advertisers can upload any in-store promotion creative of their choice. In-store promotion creative can also be used for multiple in-store promotions if desired. In the example shown in the flowchart of FIG. 1B, the promotion creative is an image file such as a JPG, PNG, or any other type of image file. In step 3, the image file is received by the promotion server, which in turn tags the image file with a name and description in step 4 and then stores the file in a creative library or database in step 5. By storing the promotion creative, the creative is available for use in other in-store promotions. The dimensions and layouts of the in-store promotion creative may be selected by the user.

Once the in-store promotion creative has been uploaded, in one embodiment, the user may select to include a barcode(s) (and the position of the barcode(s)) and dynamic text (optional) or logos. The dynamic in-store promotion text can be specified at run-time through the distribution channel or can be calculated text, such as an expiration date. The dynamic text can be provided either at run time or through predetermined fields such as “expiration date”. In yet other embodiments, the user may provide high level information of the in-store promotion such as begin date, end date, or other information.

In an embodiment in which the user (advertiser) desires to include a barcode, the process of creating a new barcode includes choosing the appropriate fields in length and position to capture the desired information. In one such embodiment, the barcodes include fields for both point-of-sale usage as well as for capturing data. Additional bar code fields can be created to capture data not previously captured. Referring again to FIG. 1B, in an embodiment in which the user desires to include a barcode, in step 6 the user determines if the desired barcode structure for the promotion exists in the system. If a desired barcode layout exists already in the system, it may be chosen from the list of existing barcode layouts. If not, the user may create a new barcode layout, which is then stored as a library element in the user's account for use in future promotions. If the desired barcode structure exists, the user may select it for the promotion in step 7 and place it on or associate it with the creative in step 8. The user may also select the position of the barcode. In one embodiment, barcodes are overlaid on the in-store promotion at runtime and can be positioned anywhere on the in-store promotion.

If the desired barcode structure does not exist in the system, in step 9 the user creates a new barcode by selecting from available barcode fields. If the user determines that the desired field exists in step 10, the user can select the existing field in step 11 and then in step 12 select the position for the field within the barcode structure. If the user determines that the desired field does not exist in step 10, the user can construct a new field in step 13 and then proceed to step 12 and select a position for the field within the barcode structure. Fields can also be created to capture information not previously available. There is no limit to the information that can be captured in a barcode.

If in step 14, the user determines that the barcode is not complete, the user returns to step 9, selects additional barcode fields and repeats the process. This process of choosing and/or creating barcode fields continues until enough fields are in the barcode to both identify the offer at the point of sale (“POS”) and capture the desired information. If in step 14 the user determines that the barcode is complete, the process returns to step 8 and the barcode is placed on or associated with the creative. In other embodiments, the user specifies a start date and expiration date for the promotion (step 15), adds geographic constraints (step 16), and/or other attributes/constraints (step 17) for the promotion. In one embodiment, the start date is the date when the in-store promotion is available for distribution to consumers. In another embodiment, the end date is the date after which the in-store promotion is no longer available for distribution to consumers.

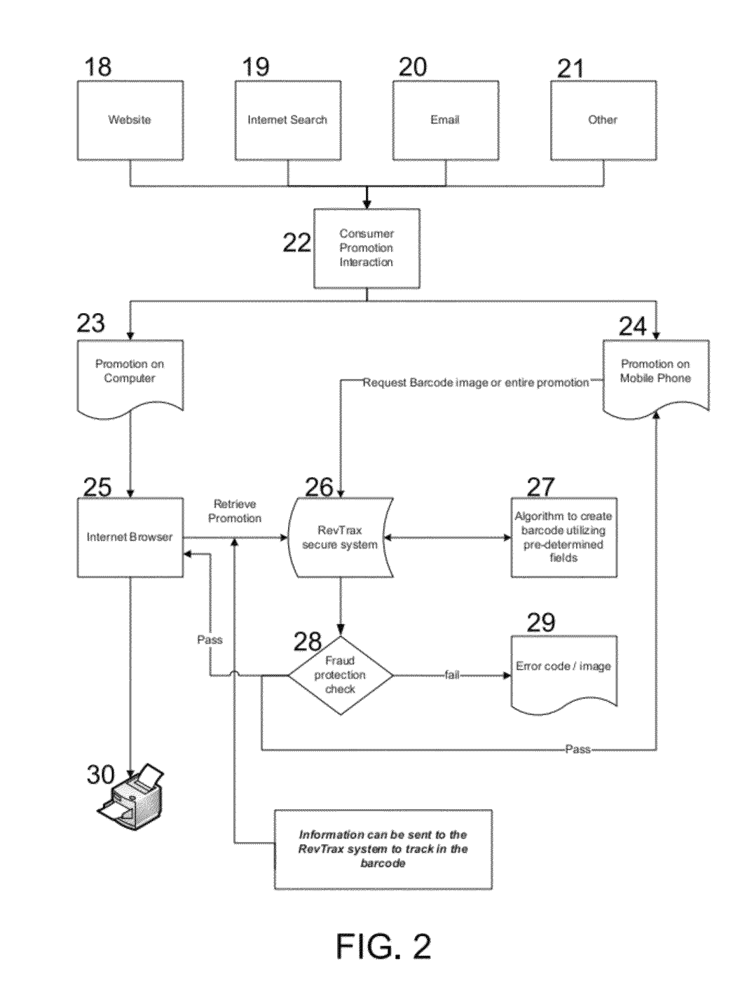

As best shown in FIG. 2, distribution channels for an in-store promotion may include the Internet (through either websites or search results), email delivery and mobile phone delivery. Therefore, a consumer may utilize a website 18, internet search 19, email 20, or other method 21 to interact with a promotion 22. The promotion may be accessed via a computer 23, mobile phone 24, or other device. If the promotion is accessed via a computer 23, in one embodiment, the computer's internet browser 25 requests the promotion from the secure system 26, which then uses an algorithm to create the barcode/promo code utilizing pre-determined fields 27 and validates the request against any security/fraud protection rules 28. If the request fails the check against the security/fraud protection rules 28, the consumer sees an error code/image 29. If the request passes the check against the security/fraud protection rules 28, the promotion is sent back to the consumer's internet browser 25 and the consumer is able to send the promotion to the printer 30 without any type of software download required.

If the promotion is accessed via a mobile phone 24, the mobile phone requests the promotion from the secure system 26, which then uses an algorithm to create the barcode/promo code utilizing pre-determined fields 27 and validates the request against any security/fraud protection rules 28. If the request fails the check against the security/fraud protection rules 28, the consumer sees an error code/image 29. If the request passes the check against the security/fraud protection rules 28, the promotion is sent back to the consumer's mobile phone 24.

Distribution channels include the internet (including but not limited to websites and search results), email delivery, mobile phone and any other technology that is able to transmit the promotion to the consumer's device. The consumer may view the in-store promotion on the internet or via an email. The consumer may open the in-store promotion in any web browser without any additional software and no registration. All fraud protection elements of the promotion are run and checked against the available data. The consumer can print the in-store promotion on any printer capable of printing graphics (no special software is required) or utilize the image on a mobile phone.

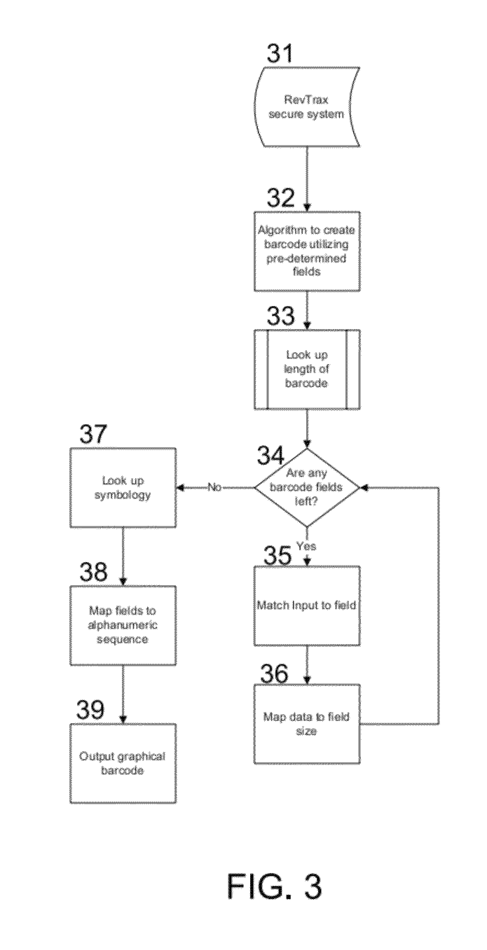

In one embodiment including barcodes in the offer, the barcodes are generated in real time utilizing all available data. The request to deliver an in-store promotion and/or a barcode and each field in the barcode is analyzed and the data is gathered. The data that covers all fields is run through an algorithm which ensures the length of the barcode and content matches the advertiser's specifications. As best shown in FIG. 3, when the secure system receives a request for a promotion in step 31, the secure system utilizes an algorithm to create a barcode utilizing predetermined fields in step 32. The system then looks up the pre-determined length of the barcode in step 33. The system then creates at least one barcode field and checks if any barcode fields are left in step 34. If any barcode fields are left in step 34, the system matches a data input to the field in step 35, and maps the data to the field, ensuring that the data fits the pre-determined field size in step 36. If any barcode fields are not left in step 34, the system looks up the predetermined symbology of the barcode in step 37, then maps the fields to an alphanumeric sequence in step 38 and generates a graphical barcode as an output in step 39.

As described above in the discussion of FIG. 2, the barcode fields that are used to capture data can be chosen from a library of fields. Fields can be created at the discretion of the advertiser to satisfy the advertiser's data capture requirements. The field lengths and the field positions may be at the discretion of the advertiser's. The barcode symbology may also be chosen by the advertiser. For example, the advertiser may select from: UPC, Code 128, EAN, GS1 Databar, QR Codes, and other type of barcode symbologies. Each of the data fields are mapped to available data that is provided to the system at runtime. When the in-store promotion is viewed, the distribution channel requests the in-store promotion from the server with all available data. The data is matched to each barcode field and formatted to fit the format specified by the advertiser. Depending on the selections of the advertiser, the same data can result in different bar codes, and may capture the same or different information for different in-store promotions.

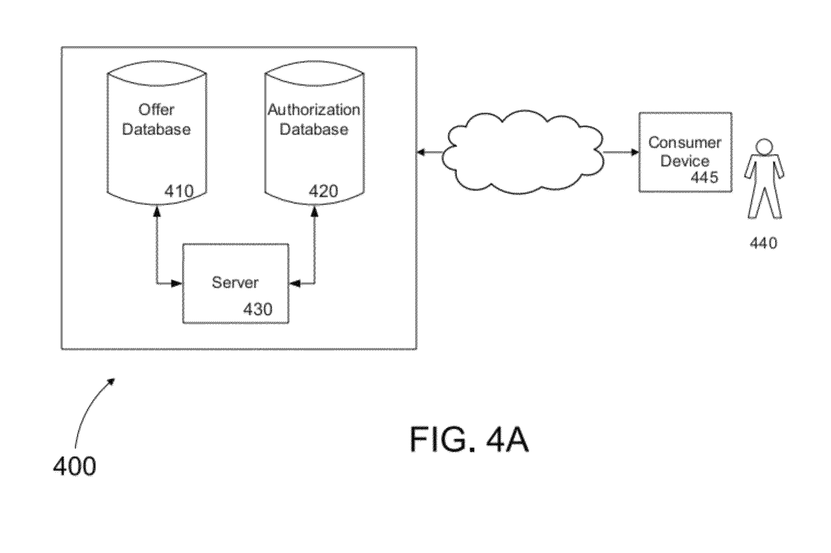

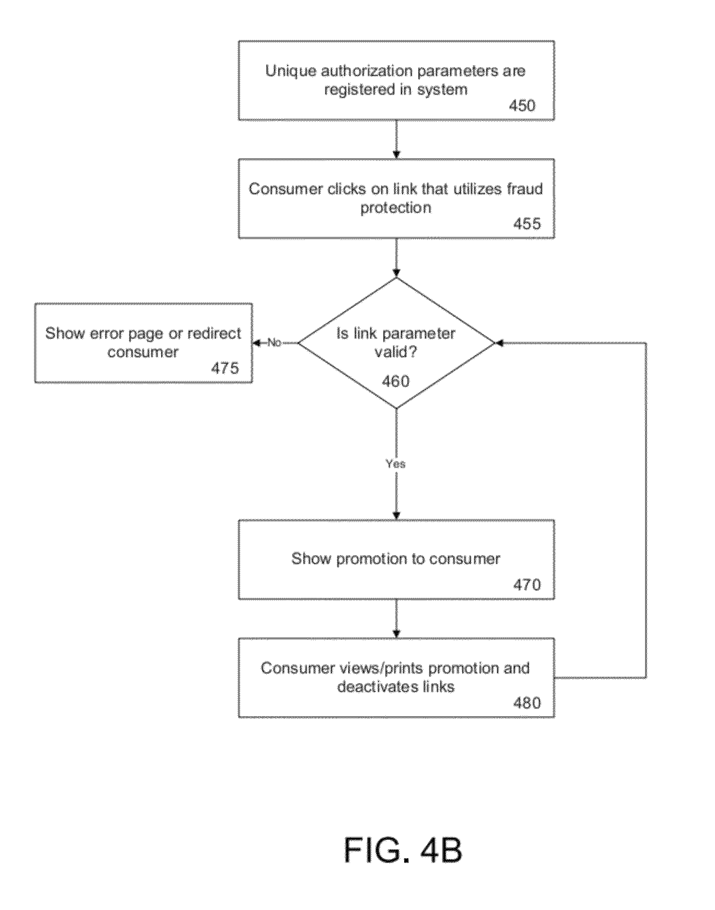

Referring now to FIG. 4A, an embodiment of a system 400 for preventing fraud and helping to ensure that only authorized consumers receive the in-store promotion is shown. The fraud prevention system 400 includes an offer database 410, an authorization database 420 and a server 430. The offer database 410 stores a plurality of offer data items for use in creating the in-store promotion. The plurality of offer data items may be fields for the user/advertiser to enter information, promotion creative such as image files, text files, sound files, video files or any combination of the foregoing, and any other of the items discussed above for use in creating an in-store promotion. The authorization database stores authorization parameters. In one embodiment, each in-store promotion sent to a consumer receives a unique authorization parameter. In another embodiment, the same authorization parameter may be used for all the targeted consumers in a campaign. The authorization parameter may be a number, an alphanumeric code, or any other identifier that may be included in a link to an in-store promotion.

The operation of the system 400 will be described in more detail using the flowchart of FIG. 4B. In step 450, unique authorization parameters for promotion links are registered in the system 400 and stored in the authorization database 420. Next, links to the in-store promotion containing the authorization parameters are sent to consumers. In step 455, a consumer 440 invokes the link to the promotion using a consumer device 445. Upon the consumer 440 invoking the link, the server 430 receives a request from the consumer device 445 to present the in-store promotion. Next, in step 460, the server 430 checks the link parameters using information from the authorization database 420 to verify that the link is valid and the request is authorized. The server 430 does not request any additional information from the consumer 440 operating the device 445 to perform the verification.

If the link is valid (i.e. contains the authorization parameter) and the request is authorized, the system 400 proceeds to step 470 and the server 430 dynamically generates the in-store promotion using at least one of the plurality of data items stored in the offer database 410 and transmits the in-store promotion to the consumer device 445. The consumer 440 may then view, print or perform another operation on the in-store promotion on the consumer device 445 in step 480.

If the link is not valid (i.e. does not contain the authorization parameter), the request is not authorized and the system 400 proceeds to step 475. In step 475, the server 430 presents an error page to the consumer 440 or redirects the consumer 440 to another page, such as the advertiser's loyalty/email club program sign up page.

In other embodiments, when the user creates the in-store promotion, the user may select a single authorization parameter or a plurality of authorization parameters to be verified by the server. In yet another embodiment, use of the authorization parameter and the authorization parameter itself are configurable by the user. For example, the authorization parameter in one embodiment may be used to limit the number of times that an in-store promotion may be printed. In this example, the user may specify the quantity. In an embodiment that the in-store promotion may only be printed a single time, to verify that the request to present an in-store promotion is valid, the server 430 must determine whether the in-store promotion was previously requested to be printed by the consumer device 445. If the user specifies that the in-store promotion may be printed no more than N times, N being a whole number greater than 1, the server 430 may track whether the in-store promotion is printed. In one such embodiment, the system 400 may track a browser identifier of the browser executing on the consumer device 445.

In another embodiment, the authorization parameter limits websites posting the in-store promotion. In order to determine if the request to present the in-store promotion is authorized, the server 430 determines whether the in-store promotion is requested through an authorized website. In one such embodiment, the authorization database 420 stores the domains of authorized websites and the server 430 verifies that the domain of a website through which the request is received is one of the authorized websites.

In still another embodiment, the authorization parameter restricts forwarding of the in-store offer by the consumer device 445.

In another embodiment, the system 400 of FIG. 4A may be used to control how many times an in-store promotion is viewed or printed by assigning a status to the authorization parameter. For example, as described above, the advertiser may desire the link to be a single-use link that may only be used to access the in-store promotion a single time. In one such embodiment, the authorization parameter is assigned a corresponding status, such as active/inactive, valid/invalid, or any other status designation that enables the system 400 to determine if the in-store promotion may be presented. Only links that contain the registered parameters having an “active” status are allowed to access the promotion. When a consumer invokes the link for the first time, the consumer can view or print the in-store promotion. For a single-use link, the status of the parameter is then changed to “inactive”. As described above, when a user invokes an invalid or deactivated link, the consumer may be shown an error message or redirected to another page, such as the advertiser's loyalty/email page. In another embodiment, the advertiser can set the number of times that an in-store promotion may be viewed and/or printed to any number that the advertiser desires.

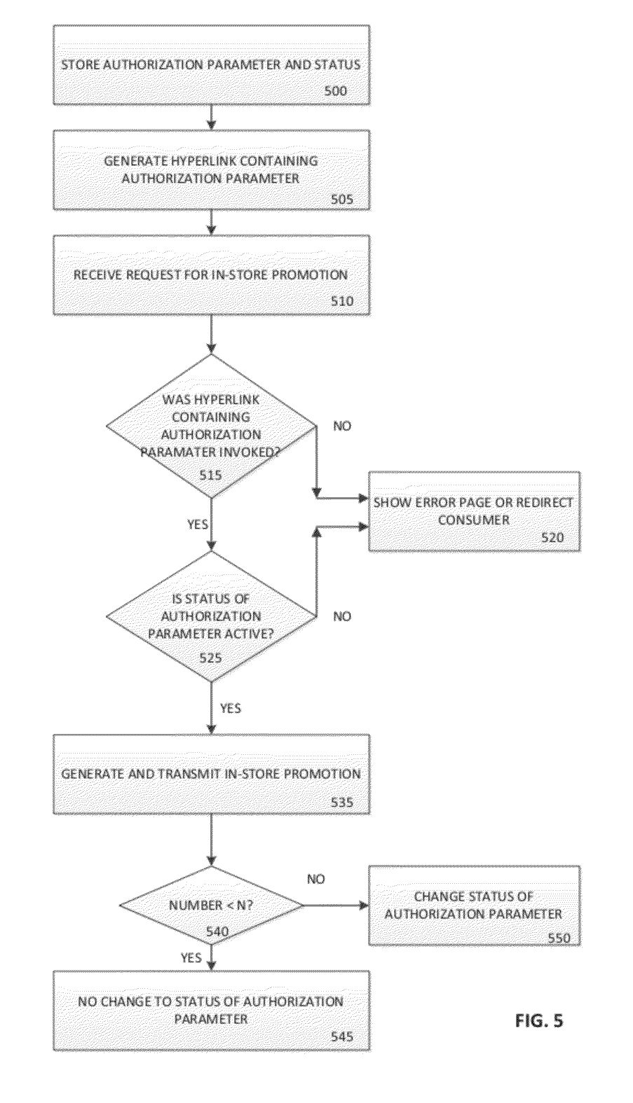

The operation of system assigning a status to the authorization parameter to control the number of times that an in-store promotion is viewed or printed will be described in more detail using the flowchart of FIG. 5. In step 500, unique authorization parameters for promotion links and a corresponding status for each of the parameters are registered in the system 400 and stored in the authorization database 420. In different embodiments, there may be a single authorization parameter, or there may be a plurality of authorization parameters. The user specifies that the in-store promotion may be viewed and/or printed no more than N times, N being a whole number equal to or greater than 1. This N value is also stored by the system 400. Next, in step 505, the server 430 generates hyperlinks to the in-store promotion containing the authorization parameters. The hyperlinks are made available to potential consumers. In one embodiment, the hyperlinks are made available to potential consumers through a digital distribution channel. In different embodiments, the digital distribution channels may be email, posting the hyperlink on an authorized website, sending a text message, or any other method of conveying information electronically.

In step 510, a consumer 440 invokes the link to the promotion using a consumer device 445. Upon the consumer 440 invoking the link, the server 430 receives a request from the consumer device 445 to present the in-store promotion in step 510. Next, in step 515, the server 430 checks the link parameters using information from the authorization database 420 to verify that the link contains one of the registered authorization parameters. The server 430 does not request any additional information from the consumer 440 operating the device 445 to perform the verification.

As described above in the discussion of FIG. 4B, if the link is not valid (i.e. does not contain the authorization parameter), the request is not authorized and the system 400 proceeds to step 520. In step 520, the server 430 presents an error page to the consumer 440 or redirects the consumer 440 to another page, such as the advertiser's loyalty/email club program sign up page.

If the link is contains a registered the authorization parameter, the system 400 proceeds to step 525 and the server 430 checks the status of the authorization parameter. If the status is “invalid”, the server 430 proceeds to step 520 as discussed above. If the status is “valid”, the server proceeds to step 535 and dynamically generates the in-store promotion using at least one of the plurality of data items stored in the offer database 410 and transmits the in-store promotion to the consumer device 445. The consumer 440 may then view, print or perform another operation on the in-store promotion on the consumer device 445.

Next, in step 540, the server 430 determines whether the in-store promotion has been viewed and/or printed a number of times less than the number N designated by the user. If the number of views/prints is less than N, the status of the authorization parameter remains the same (step 545). If the number of views/prints is greater than N, the server 430 proceeds to step 550 and changes the status of the authorization parameter to “inactive”. Once the status is changed, the link containing the authorization parameter is deactivated and may no longer be used to access the in-store promotion. In one embodiment of the system 400, this is made possible due to the in-store promotion being dynamically generated in real-time in response to the request received by the server 430.

In one embodiment utilizing authorization parameters having a status, the status is changed to inactive after a predetermined number of times that the promotion is accessed. In another embodiment, the status is changed to inactive after a predetermined number of times that a print request is made for the in-store promotion. In yet another embodiment, the status is changed to inactive after a predetermined number of times that the in-store promotion is printed.

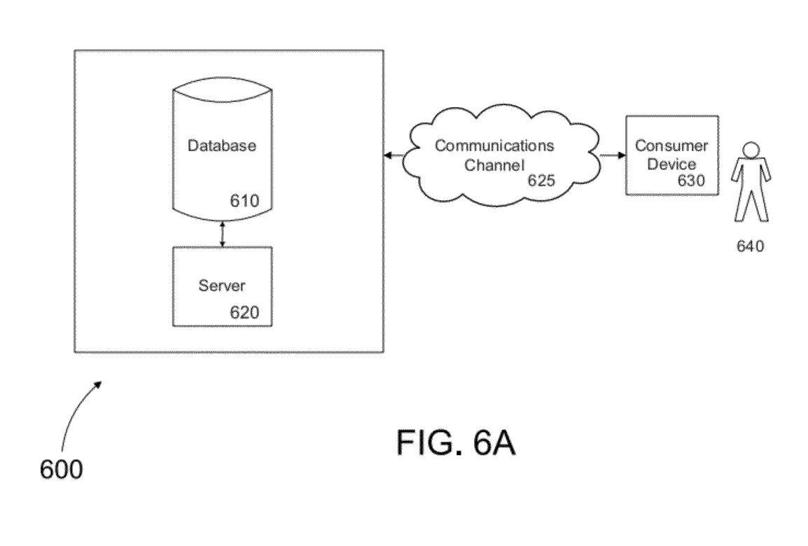

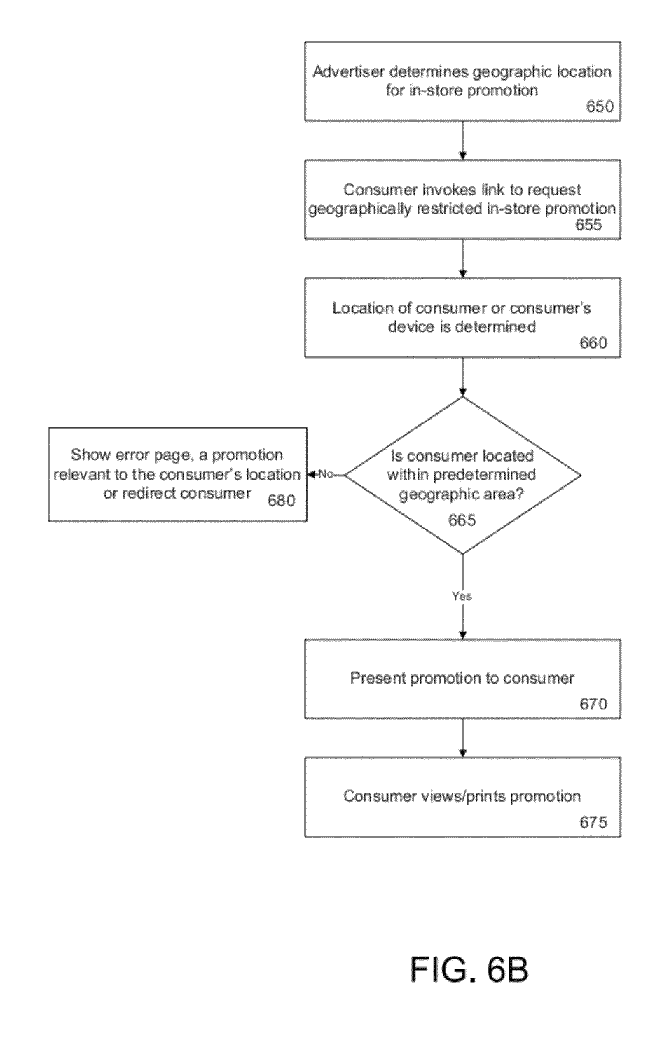

Referring now to FIG. 6A, an embodiment of a system 600 for delivering geographically restricted in-store promotions to consumers is shown. The system 600 can be thought of as a “digital fence” that only allows consumers within a predetermined geographical area to access the in-store promotion. The system 600 includes a database 610, a server 620 and a communications channel 625. The database 610 stores a plurality of offer data items for use in creating the in-store promotion. The plurality of offer data items may be fields for the user/advertiser to enter information, promotion creative such as image files, text files, sound files, video files or any combination of the foregoing, and any other of the items discussed above for use in creating an in-store promotion. The database 610 also stores at least one participating store location and/or the geographic area specified by the advertiser that may have access to the in-store promotion. In one embodiment, the geographic location or area may include the zip code(s) of the participating store(s). In another embodiment, the geographic location may include the zip code(s) of the participating store(s) and a predetermined number of zip codes surrounding the zip code(s) of the participating store(s). In yet another embodiment, the geographic location may be a geographic area defined by a set of geo-coordinates. In still another embodiment, the geographic location is a predetermined distance from the participating store(s) or other geographic point(s) (i.e. within 5 miles of a participating store). In one such embodiment the predetermined distance is a radial distance from the participating store(s) or other geographic point(s), and in another embodiment, the predetermined distance is a driving distance from the participating store(s) or other geographic point(s). In another such embodiment, the distance is an area surrounding the participating store(s) or other geographic point(s). The predetermined geographic location may be any means now known or later developed to specify a geographic area. In another embodiment, a first database stores the plurality of offer data items and a second separate database stores the participating store location(s) and/or the geographic area(s) specified by the advertiser that may have access to the in-store promotion.

The communications channel 625 may be any channel through which the server 620 may communicate with the consumer device 630. For example, the communications channel 625 may be a telephone network, a mobile telephone network, the Internet, or any other communications means, whether now known or later developed.

The operation of the system 600 will be described in more detail using the flowchart of FIG. 6B. In step 650, the advertiser specifies the geographic location(s) within which the consumer must be located in order to receive the in-store promotion. The geographic location(s) are registered in the system 600 and stored in the database 610. Next, links to the geographically restricted in-store promotion are sent to potential consumers. In step 655, a consumer 640 invokes the link to the promotion using a consumer device 630. Upon the consumer 640 invoking the link, the server 620 receives a request from the consumer device 630 to present the in-store promotion. Next, in step 660, the server 620 determines the location of the consumer 640. In one embodiment, the server 620 determines the current location of the consumer 640. In one such embodiment, the server 620 determines the position of the consumer 640 by using a global positioning system (GPS) to determine the geo-coordinates of the consumer's device 630. In another embodiment, the server 620 determines the zip code associated with the IP address of the browser executing on the consumer's device 630. In yet another embodiment, the server 620 determines the geo-coordinates associated with the IP address of the browser executing on the consumer's device 630.

Next, in step 665, the server 620 determines if the consumer is located within the predetermined geographic area specified by the advertiser. In an embodiment in which the server 620 determines the current location of the consumer 640, the server 620 determines if the current location of the consumer 640 is within the advertiser-specified geographic location(s). In an embodiment in which the server 620 uses a GPS to determine the geo-coordinates of the consumer's device 630, the server 620 compares the geo-coordinates of the consumer's device 630 to the geo-coordinates of the advertiser-specified geographic location(s) to determine if the geo-coordinates of the consumer's device 630 are within the geo-coordinates of the advertiser-specified geographic location(s). In an embodiment in which the server 620 determines the zip code associated with the IP address of the browser executing on the consumer's device 630, the server 620 determines whether the zip code of the IP address is one of the zip codes specified by the advertiser. In an embodiment in which the server 620 determines the geo-coordinates associated with the IP address of the browser executing on the consumer's device 630, the server 620 determines if the geo-coordinates of the consumer's device 630 are within the geo-coordinates of the geographic location(s) specified by the advertiser. In many embodiments, the server 620 does not request any additional information from the consumer 640 operating the device 630 to determine the location. However, in certain embodiments, the server 620 may query the consumer 640 for the consumer's location.

If the consumer 640 (or the consumer's device 630 depending on the embodiment of the system 600) is within the predetermined geographic location specified by the advertiser, the system 600 presents the in-store promotion to the consumer 640 in step 670. In one embodiment, the server 620 dynamically generates the in-store promotion using at least one of the plurality of data items stored in the database 610 and transmits the in-store promotion to the consumer device 630. Next, in step 675, the consumer 640 may view, print, or perform another operation on the in-store promotion.

If the consumer 640 (or the consumer's device 630 depending on the embodiment of the system 600) is not within the predetermined geographic location of the participating store location(s), the system 600 proceeds to step 675. In step 675, the server 620 presents an error page to the consumer 640, presents a promotion relevant for the consumer's location or redirects the consumer 640 to another page, such as the advertiser's loyalty/email club program sign up page.

Having described various embodiments of the invention, it will now become apparent to one of ordinary skill in the art that other embodiments incorporating the concepts may be used. Specifically, any combination or all of the techniques described above may be incorporated by a system for delivering in-store promotions to consumers. For example, a single system may include a tracking technique, a fraud prevention technique and a “digital fence”. It is felt, therefore, that these embodiments should not be limited to the disclosed embodiments, but rather should be limited only by the spirit and scope of the following claims.

What is claimed is:

1. A method for delivering an in-store promotion to a consumer comprising the steps of:
storing in a database a plurality of offer data items for use in creating an in-store promotion and a predetermined geographic location;
receiving at a server a request from a consumer device to present the in-store promotion;
determining by the server if the consumer device is within the predetermined geographic location without requesting additional information from a consumer operating the consumer device;
dynamically generating by the server the in-store promotion using at least one of the plurality of data items stored in the offer database if the consumer device is within the predetermined geographic location; and
transmitting the in-store promotion from the server to the consumer device.

2. The method of claim 1 wherein the predetermined geographic location is based on a participating store location and the step of determining if the consumer device is within the predetermined geographic location further comprises determining if the consumer device is within a predetermined distance from the participating store location.

3. The method of claim 1 further comprising the steps of:
storing a plurality of predetermined geographic locations; and
determining by the server if the consumer device is within at least one of the plurality of predetermined geographic locations.

4. The method of claim 1 further comprising the step of:
transmitting an error message from the server to the consumer device if the consumer device is not within the predetermined geographic location.

5. The method of claim 1 further comprising the step of:
transmitting an alternate promotion to the consumer device if the consumer device is not within the predetermined geographic location.

6. The method of claim 1 further comprising the step of:
executing a browser on the consumer device, wherein the step of transmitting the in-store promotion further comprises transmitting the in-store promotion from the server to the consumer browser.

7. The method of claim 6 further comprising the step of:
redirecting the browser if the consumer device is not within the predetermined geographic location.

8. The method of claim 7 wherein the step of redirecting the browser further comprises the step of redirecting the browser to a valid promotion.

9. The method of claim 6 wherein the step of determining if the consumer device is within a predetermined geographic location further comprises the step of:
determining if a zip code associated with an IP address of the consumer browser is within the predetermined geographic location.

10. The method of claim 9 wherein the predetermined geographic location includes at least one predetermined zip code and the step of determining if the zip code associated with the IP address of the consumer browser is within the predetermined geographic location further comprises the step of determining whether the zip code associated with the IP address is within a predetermined distance of the predetermined zip code.

11. The method of claim 1 wherein the step of determining if the consumer device is within the predetermined geographic location further comprises the step of:
determining if a set of geo-coordinates corresponding to the consumer device is within the predetermined geographic location.

12. The method of claim 6 wherein the step of determining if the consumer device is within the predetermined geographic location further comprises the step of:
determining if a set of geo-coordinates associated with an IP address of the consumer browser is within the predetermined geographic location.

13. The method of claim 1 wherein the predetermined geographic location is a distance from a predetermined geographical point.

14. The method of claim 13 wherein the distance is a radial distance.

15. The method of claim 1 wherein the predetermined geographic location is a geographic area.

16. A system for delivering a geographically restricted in-store promotion to a consumer, the system comprising:
a database storing a plurality of predetermined offer data items for use in creating an in-store promotion and a predetermined geographic location; and
a server in communication with the database, wherein upon the server receiving a request from a consumer device to present the in-store promotion, the server (i) determining if the consumer device is within the predetermined geographic location without requesting additional information from a consumer operating the consumer device; (ii) dynamically generating the in-store promotion using at least one of the plurality of data items stored in the offer database if the consumer device is within the predetermined geographic location; and (iii) transmitting the in-store promotion to the consumer device after generation.

17. The system of claim 16 wherein the predetermined geographic location is based on a participating store location.

18. The system of claim 16 wherein the database stores a plurality of predetermined geographic locations and the server determines if the consumer device is within at least one of the plurality of predetermined geographic locations.

19. The system of claim 16 wherein the server transmits an error message to the consumer device if the consumer device is not within the predetermined geographic location.

20. The method of claim 16 wherein the server transmits an alternate promotion to the consumer device if the consumer device is not within the predetermined geographic location.

21. The system of claim 16 wherein the consumer device executes a browser and the server transmits the in-store promotion to the consumer browser.

22. The system of claim 21 wherein the server redirects the browser if the consumer device is not within the predetermined geographic location.

23. The system of claim 22 wherein the server redirects the browser to a valid promotion.

24. The system of claim 21 wherein the server determines if a zip code associated with an IP address of the consumer browser is within the predetermined geographic location in order to determine if the consumer device is within the predetermined geographic location.

25. The system of claim 24 wherein the predetermined geographic location includes at least one predetermined zip code and the server determines if the zip code associated with the IP address of the consumer browser is within the predetermined geographic location by determining whether the zip code associated with the IP address is within a predetermined distance of the at least one predetermined zip code.

26. The system of claim 16 wherein the server determines if a set of geo-coordinates corresponding to the consumer device is within the predetermined geographic location.

27. The system of claim 21 wherein the server determines if a set of geo-coordinates associated with an IP address of the consumer browser is within the predetermined geographic location.

28. The system of claim 16 wherein the predetermined geographic location is a distance from a predetermined geographical point.

29. The system of claim 28 wherein the distance is a radial distance.

30. The system of claim 16 wherein the predetermined geographic location is a geographic area.
